(19) United States
(12) Patent Application Publication
(10) Pub. No.: US 2007/0067259 A1
(43) Pub. Date: Mar. 22, 2007

(54) SYSTEM AND METHOD FOR AUTOMATED COMPILING AND GENERATING ITEM LIST INFORMATION

(76) Inventors: Richard G. BRINDISI, Marco Island, FL (US); Greg A. Vittardi, Broadview Heights, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/532,275

(22) Filed: Sep. 15, 2006

Related U.S. Application Data
(60) Provisional application No. 60/717,939, filed on Sep. 16, 2005.

(51) Int. Cl. G06F 17/30

(52) U.S. Cl. 707/1

(57) ABSTRACT

A portable handheld electronic device provides automated compiling and generating of categorized item lists in accordance with user-defined preferences. In a preferred embodiment, the device includes voice recognition means adapted for recognizing the received assortment data present in received voice data. The device further includes storage means suitably adapted to store the assortment data, and categorizing means adapted for assigning respective categories to the assortment data. The assigned category is, preferably, at least one of the group including alphabetical order, similar items, temporal order, and user-defined order. Generating means compile and generate the item list that is further displayed and printed at request of the user. The device also includes interface means adapted to receive computer readable instructions corresponding to the operation of the device and/or to send the item list to a remote computer, if necessary.

### CROSS-REFERENCE TO RELATED APPLICATIONS

This application is based on and claims priority to provisional U.S. patent application Ser. No. 60/717,939, which was filed on Sep. 16, 2005.

### BACKGROUND OF THE INVENTION

The subject application relates generally to a system, method, and portable handheld electronic device for automatically compiling and generating item list information. In particular, the subject application is directed to household management and provides efficient recording of household tasks, purchases, errands, and the like. The system, method, and portable handheld electronic device of the subject application are also capable of being efficiently used in office management, business-to-business management, restaurant management, and the like. The system, method, and portable handheld electronic device of the subject application are capable of being advantageously used, for example and without limitation, by hardware, software, plumbing and building contractors, and the like.

A typical household user usually makes notations on a pad or piece of paper when certain items, such as foods and household parts, cleaners, and the like, require replacement. Generally, the same techniques are used to remind the household user of certain tasks that need to be performed, such as errands, which are written down. A problem arises, however, as the list gets longer and organization is lacking, as items at the bottom of the list should be grouped with those somewhere in the middle, and the tasks are interspersed with the food items. In addition, the list may become lost or unreadable, as typically, the list is located on a kitchen countertop, wall, or appliance. Frequently, the list is incomplete as the user is unable to locate a writing instrument to update the list with a newly desired item. Furthermore, the list is usually written by one member of the household, but when another member is asked to retrieve the items or perform the tasks, the handwriting used by the first member is illegible to the other member, resulting in items on the list that do not get purchased, or replaced, and tasks on the list that do not get performed.

There is thus a need for a system, method and device that overcomes the above mentioned problems.

It would be desirable to have a system and method that is not dependant on a handwriting and/or memory of a specific user that is capable of receiving, storing and outputting user defined item list information.

It would be also desirable to have a system and method for automatically compiling categorized item lists in accordance with user-defined preferences.

### SUMMARY OF THE INVENTION

In accordance with the subject application, there is provided a system and method for receiving, storing and outputting user defined list information.

Further, in accordance with the subject application, there is provided a system and method that is not dependent on a handwriting and/or memory of a specific user.

Still further, in accordance with the subject application, there is provided a system and method for automatically compiling categorized item lists in accordance with user-defined preferences.

Still further, in accordance with the subject application, there is provided a system for automated compiling and generating item list information including receiving means adapted for receiving, from an associated user, assortment data inclusive of at least one item. The system also includes storage means adapted for storing the received assortment data in electronic form. Also included in the system are categorizing means and generating means. The categorizing means is adapted for assigning a category to the at least one item included in the received assortment data. The assigned category is, preferably, at least one of the group including alphabetical order, similar items, temporal order, and user-defined order. The generating means is adapted for compiling and generating item list information representative of the received assortment data in accordance with the assigned category. Display means also included in the system, is adapted for displaying the item information list representative of the received assortment data in accordance with the assigned category.

In a preferred embodiment, the system for automated compiling and generating item list information further includes voice recognition means. In this embodiment, the receiving means is further adapted for receiving, from the associated user, the assortment data in a form of voice data. The voice recognition means included in the system is adapted for recognizing the received assortment data present in the voice data. In another preferred embodiment, the receiving means is adapted for receiving, from the associated user, the assortment data in a form of alphanumeric data.

In another embodiment, in accordance with the subject application, the system for automated compiling and generating item list information further includes output means adapted for outputting the item list information representative of the received assortment data in accordance with the assigned category.

The system for automated compiling and generating item list information is, preferably, a portable electronic device.

In accordance with another aspect of the subject application, there is provided a method for automated compiling and generating item list information. According to the method, assortment data inclusive of at least one item is received from an associated user and stored in electronic form. Next, a category is assigned to the at least one item included in the received assortment data. Item list information representative of the received assortment data in accordance with the assigned category is then compiled, generated and displayed.

In a preferred embodiment, the assortment data is received in a form of voice data. In this embodiment, the received assortment data present in the voice data is advantageously recognized. In another preferred embodiment, the assortment data is received in a form of alphanumeric data.

In one embodiment the item list information representative of the received assortment data in accordance with the assigned category, is further output. Preferably, the item list information representative of the received assortment data is printed in a form of a hard copy. The item list information is also capable of being communicated to a remote computer.

In accordance with yet another aspect of the subject application, there is provided a portable electronic device for automated compiling and generating item list information. The portable electronic device includes a user interface including input means and a local graphical display means. The input means is adapted for receiving, from an associated user, assortment data inclusive of at least one item. The portable electronic device includes storage means adapted for storing the received assortment data in electronic form and categorizing means adapted for assigning a category to the at least one item included in the received assortment data. The assigned category is, preferably, at least one of the group including alphabetical order, similar items, temporal order, and user-defined order. Also included in the portable electronic device are generating means and output means. The generating means is adapted for compiling and generating item list information representative of the received assortment data in accordance with the assigned category. The local graphical display means of the portable electronic device of the subject application is adapted for displaying the item list information representative of the received assortment data in accordance with the assigned category. The output means is adapted for outputting the item list information.

In a preferred embodiment, the input means of the portable electronic device of the subject application is further adapted for receiving, from an associated user, the assortment data in a form of voice data. In this embodiment, the portable electronic device further includes voice recognition means adapted for recognizing the received assortment data present in the voice data. In another preferred embodiment, the input means is adapted for receiving, from an associated user, the assortment data in a form of alphanumeric data.

In another preferred embodiment, the portable electronic device includes mounting means adapted for mounting the portable handheld device on at least one of the group including a vertical surface, a horizontal surface, and a household appliance. In another preferred embodiment, the portable electronic device includes printing means adapted for printing the item list information representative of the received assortment data in a form of a hard copy. Preferably, the input means is further adapted for editing the item list information so as to remove at least one item from the list. The portable electronic device is, preferably, a handheld device.

Still other aspects of the present invention will become readily apparent to those skilled in this art from the following description wherein there is shown and described a preferred embodiment of this invention, simply by way of illustration of one of the best modes suited for carrying out the invention. As it will be realized, the invention is capable of other different embodiments and its several details are capable of modifications in various obvious aspects all without departing from the invention. Accordingly, the drawing and description will be regarded as illustrative in nature and not as restrictive.

### BRIEF DESCRIPTION OF THE DRAWINGS

The accompanying drawing incorporated in and forming a part of the specification illustrate several aspects of the present invention and serve to explain the principles of the invention.

FIG. 1 is a diagram illustrating one embodiment of a portable handheld electronic device in accordance with the present invention;

FIG. 2 is a diagram illustrating another embodiment of a portable handheld electronic device in accordance with the present invention; and

FIG. 3 is a flowchart illustrating a method for automated compiling and generating item list information according to the subject application as illustrated in FIG. 1.

FIG. 4 is a flowchart illustrating a method for automated compiling and generating item list information according to the subject application as illustrated in FIG. 2.

### DETAILED DESCRIPTION OF THE PREFERRED EMBODIMENT

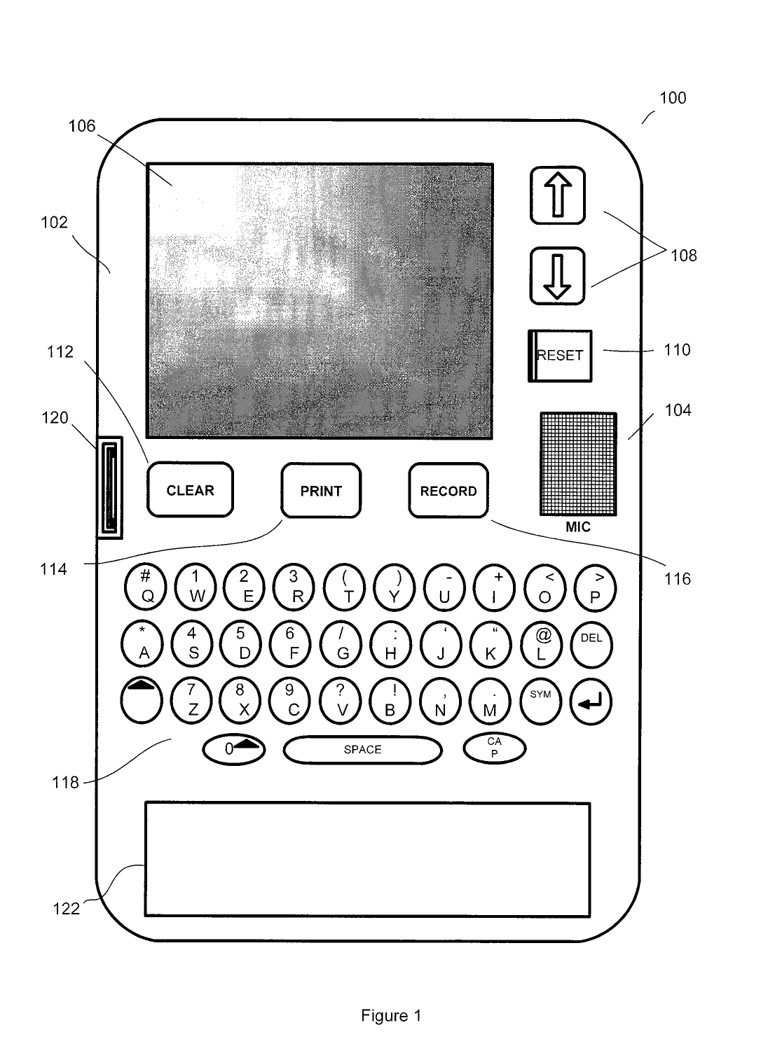

The subject application is directed to household management and provides efficient recording of household tasks, purchases, errands, and the like. More particularly, the subject application is directed to a system, method, and device suitably adapted to receive, store and output user defined list information. In particular, the subject application is directed to a system, method, and portable device capable of receiving assortment data from an associated user, compiling the assortment data into a list in a predetermined order, and outputting the same in accordance with a user initiated command. It will become apparent to those skilled in the art that the system, method, and portable handheld device described herein are suitably adapted to a plurality of varying applications including, for example and without limitation, office management, business-to-business management, restaurant management, and the like. The preferred embodiment, as depicted in FIG. 1, illustrates a portable handheld device for example purposes only and is not a limitation of the subject invention solely to such devices.

Referring now to FIG. 1, there is shown a preferred embodiment of a portable electronic device 100 in accordance with the present invention. The portable electronic device 100 is illustrated in FIG. 1 as a handheld device including a casing 102. In accordance with the present invention, the portable electronic device is, preferably, constructed of a suitable plastic or lightweight metal material. When lightweight metal is used, preferable the casing 102, or outer portion of the device is advantageously covered in a dielectric membrane, as will be known in the art. Preferably, the color of the device is selected by the user so as to match the appliances of the home in which the device will be used. It will be appreciated by those skilled in the art that suitable colors include, but are not limited to, black, white, almond, stainless steel (graphite), and the like. In a preferred embodiment, the device is capable of being affixed to a horizontal surface, such as a countertop, a vertical surface, such as a wall, or a household appliance, such as a refrigerator (not shown in the drawing). Means for securing the device mounting include, but are not limited to, adhesives, magnets, screws, and the like. Preferably, the mounting is accomplished with a separate mounting bracket, which is secured to the mounting surface and which is capable of receiving and holding the device.

As will be appreciated by those skilled in the art, the portable electronic device 100 further includes storage means, such as internal memory, so as to retain an operating system, list data, application-related instructions, voice recognition software, and the like (not shown in the drawing). Suitable memory includes non-volatile memory, flash memory, optical memory, or any combination thereof. Preferably, the device includes a microprocessor suitably adapted to facilitate operation of the device in accordance with the methods described herein. Suitable operating systems include, but are not limited to, Windows-based systems, Palm-based systems, RIM-based systems, Linux-based systems, and the like. The device further includes an integrated microphone 104, suitably adapted to receive voice communications from an associated user. Voice communications are suitably processed, via the processor, using voice recognition software, so as to generate an electronic item for storage on the device memory. The processor further includes the ability to organize and categorize items in accordance with user-defined preferences.

The portable electronic device 100 also includes a display 106, such as a backlit LCD display, a touchscreen display, and the like. The display 106 is capable of illustrating to the user those items stored in memory, as well as enabling the user to select options and settings, as will be appreciated by those skilled in the art. To facilitate data entry and user selection, in addition to the integrated microphone 104, the portable electronic device 100 further includes tactile input keys, such as for example and without limitation, scroll keys 108, a delete key 110, a reset or clear key 112, a print key 114, a record key 116, an alphanumerical pad 118, and the like. Those skilled in the art will appreciate that each tactile input key is advantageously programmed to reflect a function of the device. The device further includes data connection means 120, such as a universal serial bus (USB) port, and/or an IEEE 1394 (Firewire) port, and the like, so as to enable the device to save data to an associated user computer (not shown), receive updates therefrom, to improve voice recognition, or any combination thereof. To facilitate output of a categorized list of the items stored in the device memory, the portable electronic device 100 incorporates an integrated printing engine (not shown). Preferably, the printing engine is capable of outputting a hardcopy of the list so as to enable the user to print a copy of the list and leave the device securely affixed to the mounting surface. Shown in FIG. 1, is a paper roll holder door 122, wherein the paper roll is associated with the printing engine.

In one embodiment, the portable electronic device 100 employs rechargeable batteries, as are known in the art, suitably recharged via the data connection means, or alternatively via a docking station (not shown). Those skilled in the art will recognize that the portable electronic device 100 is capable of being implemented with non-rechargeable batteries, such as AA batteries, and the like.

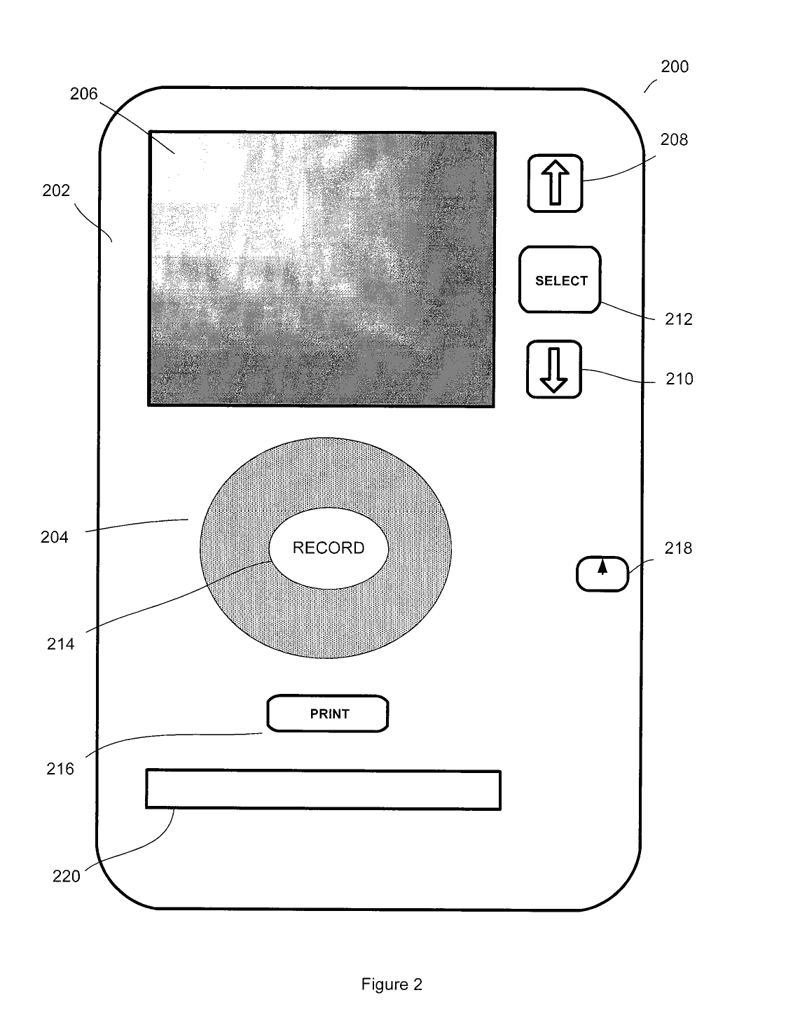

Referring now to FIG. 2, there is shown another preferred embodiment of a portable electronic device 200 in accordance with the present invention. The portable electronic device 200 is illustrated in FIG. 2 as a handheld device including a casing 202. In accordance with the present invention, the portable electronic device is, preferably, constructed of a suitable plastic or lightweight metal material. When lightweight metal is used, preferable the casing 202, or outer portion of the device is advantageously covered in a dielectric membrane, as will be known in the art. It will be appreciated by those skilled in the art that the casing 202 is capable of being covered with a suitable color coating, the colors including, but not limited to, black, yellow, medium grey, and the like. In a preferred embodiment, the device is capable of being affixed to a horizontal surface, such as a countertop, a vertical surface, such as a wall, or a household appliance, such as a refrigerator (not shown in the drawing). Means for securing the device mounting include, but are not limited to, adhesives, magnets, screws, and the like. Preferably, the mounting is accomplished with a separate mounting bracket, which is secured to the mounting surface and which is capable of receiving and holding the device (not shown in the drawing).

As will be appreciated by those skilled in the art, the portable electronic device 200 further includes storage means, such as internal memory, so as to retain an operating system, list data, application-related instructions, voice recognition software, and the like (not shown in the drawing). Suitable memory includes non-volatile memory, flash memory, optical memory, or any combination thereof. Preferably, the device includes a microprocessor suitably adapted to facilitate operation of the device in accordance with the methods described herein. Suitable operating systems include, but are not limited to, Windows-based systems, Palm-based systems, RIM-based systems, Linux-based systems, and the like. The device further includes an integrated microphone 204, suitably adapted to receive voice communications from an associated user. Voice communications are suitably processed, via the processor, using voice recognition software, so as to generate an electronic item for storage on the device memory. The processor further includes the ability to organize and categorize items in accordance with user-defined preferences.

The portable electronic device 200 also includes a display 206, such as a backlit LCD display, a touchscreen display, and the like. The display 206 is capable of illustrating to the user those items stored in memory, as well as enabling the user to select options and settings, as will be appreciated by those skilled in the art. To facilitate data entry and user selection, in addition to the integrated microphone 204, the portable electronic device 200, as illustrated in FIG. 2, further includes tactile input keys, such as for example and without limitation, scroll keys 208, 210, a select key 212, a record key 214, and a print key 216. The portable electronic device 200 also includes an “on”-“off” button 218. Those skilled in the art will appreciate that each tactile input key is advantageously programmed to reflect a function of the device. The device 200 further includes data connection means, such as a universal serial bus (USB) port, and/or an IEEE 1394 (Firewire) port, and the like, so as to enable the device to save data to an associated user computer (not shown), receive updates therefrom, to improve voice recognition, or any combination thereof. To facilitate output of a categorized list of the items stored in the device memory, the portable electronic device 200 incorporates an integrated printing engine (not shown). Preferably, the printing engine is capable of outputting a hardcopy of the list so as to enable the user to print a copy of the list and leave the device securely affixed to the mounting surface. Shown in FIG. 2, is a paper roll holder door 220, wherein the paper roll is associated with the printing engine.

Those skilled in the art will recognize that the portable electronic device 200 is capable of being implemented with non-rechargeable batteries, such as AA batteries, and the like. Referring now to operation of the portable electronic device 100 shown in FIG. 1, the operation commences by an associated user selecting the record key 116 of the device 100. When an associated user desires to input assortment data in a form of voice data, the associated user, after selecting the record key 116, speaks an item the user desires to add to the list. For example, items suitably include, but are not limited to, food, tasks, errands, household parts, and the like. The voice recognition software recognizes the voice communication from the associated user via the integrated microphone 104 and converts the communication to computer-readable format, such as a text file, or the like. Suitable commercially available voice recognition software includes, but is not limited to, the VoCon® 3200 Embedded Development System v.2.0, from ScanSoft, Inc., and the like. The entered item is then stored in the list, which is organized, or categorized, in accordance with a predefined overall organization, such as for example, and without limitation, by type of item, by date entered, in alphabetical order, any combination thereof, and the like. The item is then displayed on the display screen 106. When the item is incorrect, the associated user is able to delete the item and try again by selecting the item via the microphone 104, via scroll keys 108 or touchscreen interface, which the device may advantageously include, and delete the item using the delete key 110. A skilled artisan will understand that all items are capable of being deleted, if requested so.

Similarly, when the user desires to print the item list, the user selects the print key 114 and the item list is output via the printing engine using any means known in the art. Suitable printing means included ink-based printing, laser/toner-based printing, thermal-image printing, and the like. Those skilled in the art will appreciate that the type of printing used is dependent upon the device capabilities, thus when the device is configured, in accordance with one embodiment, with a thermal printer, thermally-activated paper is used. Likewise, when ink-based printing is used, regular paper, such as a calculator roll, is capable of being used to output the list. Preferably, the device includes a serrated portion, advantageously located near the output of the printer to facilitate the removal of the hardcopy list. As will be understood by a skilled artisan, the item list is capable of being printed by an associated printer or by a printer associated with a remote computer by outputting the item list to the respective computer.

When a user desires to input assortment data in a form of alphanumerical data, the alphanumerical pad 118 is used. Then the device operates similarly to that as when the voice data input is used. A skilled artisan will appreciate that a quantity of desired items is also capable of being similarly designated by the user using voice data input or alphanumerical data input. Those skilled in the art will recognize that a coupon for any item added to the list is capable of being suitably designated in a similar manner.

In a preferred embodiment, the device is capable of being advantageously provided with suitable settings for the microphone performance and for the LCD display contrast, such as “low”, “medium”, and “high” (not shown in the drawing).

As will be appreciated by those skilled in the art, typical voice recognition software uses preloaded master databases, which in accordance with the subject application is capable of including several thousands of items. However, a skilled artisan will understand that the system, method and device of the subject application allow for the user to easily add unique items or brands using voice data input through the microphone 104 or alphanumerical data input through the keypad 118. Similarly, unwanted items are capable of being deleted from the master database. In a preferred embodiment of the subject application, the recognition rate is as high as 98%.

Referring now to operation of the portable electronic device 200 illustrated in FIG. 2, the operation commences by an associated user selecting the record key 214 of the device 200. When an associated user desires to input assortment data in a form of voice data, the associated user, after selecting the record key 216, speaks an item the user desires to add to the list. For example, items suitably include, but are not limited to, food, tasks, errands, household parts, and the like. Similar to that described with reference to the embodiment of FIG. 1, the voice recognition software recognizes the voice communication from the associated user via the integrated microphone 204 and converts the communication to computer-readable format, such as a text file, or the like. Suitable commercially available voice recognition software includes, but is not limited to, the VoCon® 3200 Embedded Development System v.2.0, from ScanSoft, Inc., and the like. The entered item is then stored in the list, which is organized, or categorized, in accordance with a predefined overall organization, such as for example, and without limitation, by type of item, by date entered, in alphabetical order, any combination thereof, and the like. The item is then displayed on the display screen 206. When the item is incorrect, the associated user is able to delete the item via the select key 212, via scroll keys 208, 210 and/or touchscreen interface, which the device may advantageously include, using a suitable menu advantageously displayed on the display screen 206. A skilled artisan will understand that all items are capable of being deleted, if requested so. Those skilled in the art will recognize that an item or items are also capable of being deleted via the microphone 204.

Similarly, when the user desires to print the item list, the user selects the print key 216 and the item list is output via the printing engine using any means known in the art. Suitable printing means included ink-based printing, laser/toner-based printing, thermal-image printing, and the like. Those skilled in the art will appreciate that the type of printing used is dependent upon the device capabilities, thus when the device is configured, in accordance with one embodiment, with a thermal printer, thermally-activated paper is used. Likewise, when ink-based printing is used, regular paper, such as a calculator roll, is capable of being used to output the list. Preferably, the device includes a serrated portion, advantageously located near the output of the printer to facilitate the removal of the hardcopy list. As will be understood by a skilled artisan, the item list is capable of being printed by an associated printer or by a printer associated with a remote computer by outputting the item list to the respective computer.

When a user desires to input assortment data in a form of alphanumerical data, the select key 212 is used. The later prompts an alphanumerical pad (not shown) to be advantageously displayed on the display screen 206. When necessary data is input by the associated user via a suitable touchscreen interface, the device operates similarly to that as when the voice data input is used. A skilled artisan will appreciate that a quantity of desired items is also capable of being similarly designated by the user using voice data input or alphanumerical data input. Those skilled in the art will recognize that a coupon for any item added to the list is capable of being suitably designated in a similar manner.

In a preferred embodiment, the device is capable of being advantageously provided with suitable settings for the microphone performance and for the LCD display contrast, such as “low”, “medium“, and “high” (not shown in the drawing).

As will be appreciated by those skilled in the art, typical voice recognition software uses preloaded master databases, which in accordance with the subject application is capable of including several thousands of items. However, a skilled artisan will understand that the system, method and device of the subject application allow for the user to easily add unique items or brands using voice data input through the microphone 204 or alphanumerical data input through the keypad displayed on the screen display 206. Similarly, unwanted items are capable of being deleted from the master database. In a preferred embodiment of the subject application, the recognition rate is as high as 98%.

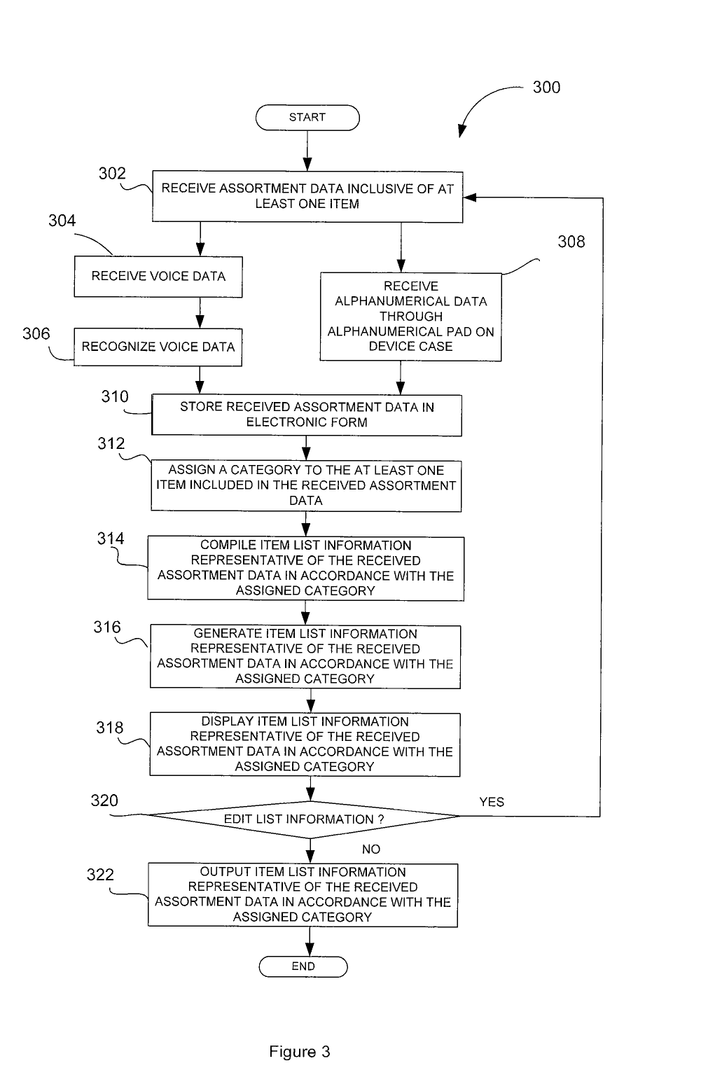

The foregoing device 100 illustrated in FIG. 1, will better be understood when viewed in conjunction with the methodologies set forth in FIG. 3. Turning now to FIG. 3, there is shown a flowchart 300 illustrating a method for automated compiling and generating item list information according to the subject application. Beginning at step 302, the process of receiving assortment data inclusive of at least one item, is initiated by selecting the record key 116 of the device 100. Next, if the associated user desires to input the assortment data information in the form of voice data, flow proceeds to step 304, in which assortment data inclusive of at least one item is received from an associated user with the aid of the integrated microphone 104. The associated user speaks a desired item, which as mentioned above, is capable of suitably including, for example and without limitation, food, tasks, errands, household parts, and the like. At step 306 the voice recognition software recognizes the voice communication from the associated user and converts the communication to computer-readable format, such as a text file, or the like. As mentioned above, suitable commercially available voice recognition software includes, but is not limited to, the VoCon® 3200 Embedded Development System v.2.0, from ScanSoft, Inc., and the like. At step 310 assortment data is stored in electronic form by suitable storage means, as mentioned above.

If the associated user desires to input the assortment data information in the form of alphanumerical data, flow from step 302 proceeds to step 308, in which assortment data inclusive of at least one item is received from an associated user with the aid of the alphanumerical pad 118. At step 310 assortment data received in the form of alphanumerical data, is stored in electronic form by suitable storage means, as mentioned above.

After assortment data information is received, either in the form of voice data, or in the form of alphanumerical data, flow proceeds to step 312, at which a category is assigned to the at least one item included in the received assortment data by categorizing means. Those skilled in the art will appreciate that the categorizing means are capable of being implemented as a suitable processor known in the art (not shown in the drawing). As will be understood by a skilled artisan, the processor suitably includes the ability to organize and categorize items in accordance with user-defined preferences, such as for example, and without limitation, by type of item, by date entered, in alphabetical order, any combination thereof, and the like. Next, list information representative of the received assortment data in accordance with the assigned category, is compiled by the processor at step 314 and generated at step 316.

At step 318, the display 106 displays list information generated at step 316. In the event that the associated user does not desire to edit list information, flow proceeds to step 322. At step 322 list information representative of the received assortment data in accordance with the assigned category, is suitably output. The list information is capable of being output at step 322 by suitably printing a hard copy of the list using an integrated printing engine (not shown), thereby selecting the print key 114. Shown in FIG. 1, is the paper roll holder door 122, wherein the paper roll for printing the list information is associated with the printing engine.

Alternatively, at step 322 the list information is capable of being delivered to an associated printer or to a printer associated with a remote computer by outputting the item list to the respective computer via suitable data connection means 120, such as for example, and not limited to, a universal serial bus (USB) port, and/or an IEEE 1394 (Firewire) port.

In the event that the associated user does desire to edit the list information displayed by the display 106, flow returns to step 302 and further to step 304 and step 306, or to step 308. The associated user is now capable to add one ore more items to the list, or delete one or more items, as well as delete the entire list, advantageously using scroll keys 108, the delete key 110, the clear key 112, the alphanumerical pad 118, or the microphone 104. As a skilled artisan will appreciate, after the list information displayed by the display 106 is edited, flow proceeds to step 310, and further as illustrated in FIG. 3, in the same manner as described above.

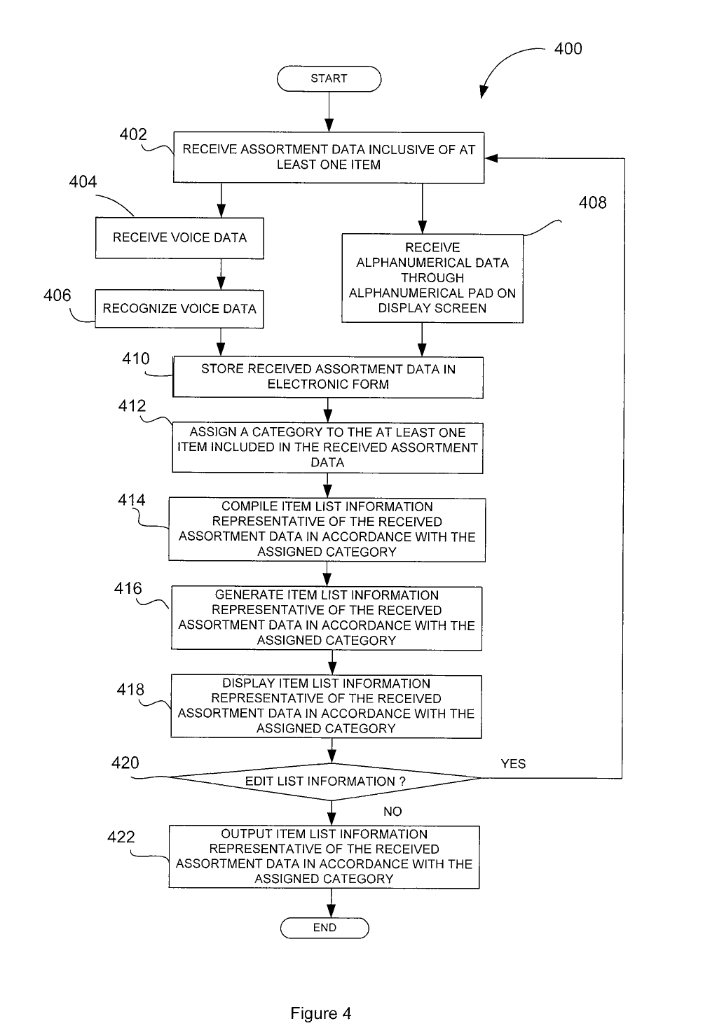

The foregoing device 200 illustrated in FIG. 2, will better be understood when viewed in conjunction with the methodologies set forth in FIG. 4. Turning now to FIG. 4, there is shown a flowchart 400 illustrating a method for automated compiling and generating item list information according to the subject application. Beginning at step 402, the process of receiving assortment data inclusive of at least one item, is initiated by selecting the record key 214 of the device 200. Next, if the associated user desires to input the assortment data information in the form of voice data, flow proceeds to step 404, in which assortment data inclusive of at least one item is received from an associated user with the aid of the integrated microphone 204. The associated user speaks a desired item, which as mentioned above, is capable of suitably including, for example and without limitation, food, tasks, errands, household parts, and the like. At step 406 the voice recognition software recognizes the voice communication from the associated user and converts the communication to computer-readable format, such as a text file, or the like. As mentioned above, suitable commercially available voice recognition software includes, but is not limited to, the VoCon® 3200 Embedded Development System v.2.0, from ScanSoft, Inc., and the like. At step 410 assortment data is stored in electronic form by suitable storage means, as mentioned above.

If the associated user desires to input the assortment data information in the form of alphanumerical data, flow from step 402 proceeds to step 408, in which assortment data inclusive of at least one item is received from an associated user via the select key 212, scroll keys 208, 210, and with the aid of an alphanumerical pad displayed on the display screen 206. At step 410 assortment data received in the form of alphanumerical data, is stored in electronic form by suitable storage means, as mentioned above.

After assortment data information is received, either in the form of voice data, or in the form of alphanumerical data, flow proceeds to step 412, at which a category is assigned to the at least one item included in the received assortment data by categorizing means. Those skilled in the art will appreciate that the categorizing means are capable of being implemented as a suitable processor known in the art (not shown in the drawing). As will be understood by a skilled artisan, the processor suitably includes the ability to organize and categorize items in accordance with user-defined preferences, such as for example, and without limitation, by type of item, by date entered, in alphabetical order, any combination thereof, and the like. Next, list information representative of the received assortment data in accordance with the assigned category, is compiled by the processor at step 414 and generated at step 416.

At step 418, the display 206 displays list information generated at step 416. In the event that the associated user does not desire to edit list information, flow proceeds to step 422. At step 422 list information representative of the received assortment data in accordance with the assigned category, is suitably output. The list information is capable of being output at step 422 by suitably printing a hard copy of the list using an integrated printing engine (not shown), thereby selecting the print key 216. Shown in FIG. 2, is the paper roll holder door 220, wherein the paper roll for printing the list information is associated with the printing engine.

Alternatively, at step 422 the list information is capable of being delivered to an associated printer or to a printer associated with a remote computer by outputting the item list to the respective computer via suitable data connection means (not shown in FIG. 2), such as for example, and not limited to, a universal serial bus (USB) port, and/or an IEEE 1394 (Firewire) port.

In the event that the associated user does desire to edit the list information displayed by the display 206, flow returns to step 402 and further to step 404 and step 406, or to step 408. The associated user is now capable to add one ore more items to the list, or delete one or more items, as well as delete the entire list, advantageously using the select key 212, the scroll keys 208, 210, and/or the touchscreen interface, which the device 200 may advantageously include, via a suitable menu advantageously displayed on the display screen 206. Those skilled in the art will recognize that an item or items are also capable of being deleted or added via the microphone 204.

As a skilled artisan will appreciate, after the list information displayed by the display screen 206 is edited, flow proceeds to step 410, and further as illustrated in FIG. 4, in the same manner as described above.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for automated compiling and generating item list information comprising:
receiving means adapted for receiving, from an associated user, assortment data inclusive of at least one item;
storage means adapted for storing the received assortment data in electronic form;
categorizing means adapted for assigning a category to the at least one item included in the received assortment data;
generating means adapted for compiling and generating item list information representative of the received assortment data in accordance with the assigned category; and
display means adapted for displaying the item list information representative of the received assortment data in accordance with the assigned category.

2. The system for automated compiling and generating item list information of claim 1 further comprising voice recognition means, wherein the receiving means is further adapted for receiving, from the associated user, the assortment data in a form of voice data, and wherein the voice recognition means is adapted for recognizing the received assortment data present in the voice data.

3. The system for automated compiling and generating item list information of claim 1, wherein the receiving means is further adapted for receiving, from the associated user, the assortment data in a form of alphanumeric data.

4. The system for automated compiling and generating item list information of claim 1 further comprising output means adapted for outputting the item list information representative of the received assortment data in accordance with the assigned category.

5. The system for automated compiling and generating item list information of claim 1 wherein the assigned category is at least one of the group including alphabetical order, similar items, temporal order, and user-defined order.

6. The system for automated compiling and generating item list information of claim 1 wherein the system is a portable electronic device.

7. A method for automated compiling and generating item list information comprising the steps:
receiving, from an associated user, assortment data inclusive of at least one item;
storing the received assortment data in electronic form;
assigning a category to the at least one item included in the received assortment data;
compiling item list information representative of the received assortment data in accordance with the assigned category;
generating item list information representative of the received assortment data in accordance with the assigned category; and
displaying the item list information representative of the received assortment data in accordance with the assigned category.

8. The method for automated compiling and generating item list information of claim 7 wherein the step of receiving further comprises receiving the assortment data in a form of voice data, and recognizing the received assortment data present in the voice data.

9. The method for automated compiling and generating item list information of claim 7 wherein the step of receiving further comprises receiving the assortment data in a form of alphanumeric data.

10. The method for automated compiling and generating item list information of claim 7 further comprising the step of outputting the item list information representative of the received assortment data in accordance with the assigned category.

11. The method for automated compiling and generating item list information of claim 10 wherein the step of outputting the item list information further comprises printing the item list information representative of the received assortment data in a form of a hard copy.

12. The method for automated compiling and generating item list information of claim 10 wherein the step of outputting the item list information further comprises the step of communicating the item list information representative of the received assortment data to a remote computer.

13. A portable electronic device for automated compiling and generating item list information comprising:
a user interface including input means and a local graphical display means, the input means adapted for receiving, from an associated user, assortment data inclusive of at least one item;
storage means adapted for storing the received assortment data in electronic form;
categorizing means adapted for assigning a category to the at least one item included in the received assortment data;
generating means adapted for compiling and generating item list information representative of the received assortment data in accordance with the assigned category; and
output means adapted for outputting the item list information representative of the received assortment data in accordance with the assigned category;
wherein the local graphical display means is adapted for displaying the item list information representative of the received assortment data in accordance with the assigned category.

14. The portable electronic device for automated compiling and generating item list information of claim 13 further comprising voice recognition means, wherein the input means is further adapted for receiving, from an associated user, the assortment data in a form of voice data, and wherein the voice recognition means is adapted for recognizing the received assortment data present in the voice data.

15. The portable electronic device for automated compiling and generating item list information of claim 13, wherein the input means is further adapted for receiving, from an associated user, the assortment data in a form of alphanumeric data.

16. The portable electronic device for automated compiling and generating item list information of claim 13, further comprising printing means adapted for printing the item list information representative of the received assortment data a form of a hard copy.

17. The portable electronic device for automated compiling and generating item list information of claim 13 further comprising mounting means adapted for mounting the portable handheld device on at least one of the group including a vertical surface, a horizontal surface, and a household appliance.

18. The portable electronic device for automated compiling and generating item list information of claim 13 wherein the assigned category is at least one of the group including alphabetical order, similar items, temporal order, and user-defined order.

19. The portable electronic device for automated compiling and generating item list information of claim 13 wherein the input means is further adapted for editing the item list information so as to remove at least one item from the list.

20. The portable electronic device for automated compiling and generating item list information of claim 13, wherein the portable electronic device is a handheld device.
